(19) United States
(12) Patent Application Publication
(10) Pub. No.: US 2023/0324207 A1
(43) Pub. Date: Oct. 12, 2023

(54) ULTRASONIC MEASURING DEVICE AND METHOD FOR PRODUCTION THEREOF

(71) Applicant: Endress+Hauser Flowtec AG, Reinach (CH)

(72) Inventors: Oliver Berberig, Grenzach-Wyhlen (DE); Andreas Berger, Erschwil (CH); Manuel Martini, Schallbach (DE); Achim Stark, Dörfles/Esbach (DE); Rudolf Braun, Ahorn (DE); Jens Rautenberg, Geseke (DE)

(21) Appl. No.: 18/042,233

(22) PCT Filed: Jul. 16, 2021
(86) PCT No.: PCT/EP2021/069997

§ 371 Date: Feb. 20, 2023

(30) Foreign Application Priority Data
Aug. 18, 2020 (DE) 10 2020 121 678.5

(51) Int. Cl. G01F 1/66; G01F 1/667

(52) U.S. Cl. CPC G01F 1/662; G01F 1/667

(57) ABSTRACT

An ultrasonic measuring device for measuring properties of a medium located in a measuring tube includes a measuring tube wall and a measuring tube lumen. The measuring tube wall has at least one acoustic region designed to be excited into Lamb oscillations. A pair of ultrasonic transducers are located in a coupling region and are designed to excite Lamb oscillations or to detect Lamb oscillations in the respective coupling regions. The device also includes an electronic measuring/operating circuit. A supporting device is designed to support at least parts of the acoustic region against media pressure, and at least one supporting member is designed to absorb forces generated by media pressure. The supporting member has at least one decoupling device which is designed to reduce ultrasonic input from at least one associated acoustic region into the supporting member, and vice versa.

The invention relates to an ultrasonic measuring device for measuring at least one property of a medium located in a measuring tube, and to a method for producing a component of such an ultrasonic measuring device.

Ultrasonic measuring devices exist in many variants; for example, DE102018133066A1 discloses an ultrasonic measuring device in which a measuring tube with a rectangular cross-section has a flat wall, in sections, on which ultrasonic transducers are located. Such an implementation has the disadvantage that the wall in the flat region reacts very sensitively to high media pressures, and bulges.

The object of the invention is to propose an ultrasonic measuring device which can be used even at high media pressures.

The object is achieved by an ultrasonic measuring device according to independent claim 1, and by a method according to independent claim 14.

An ultrasonic measuring device according to the invention, based upon the transit time principle or the transit time difference principle for measuring at least one property of a medium located in a measuring tube, comprises:
the measuring tube with a measuring tube wall and a measuring tube lumen;
wherein the measuring tube wall has at least one acoustic region, in each case having at least one coupling region, in which the measuring tube wall is flat and has a constant, first wall thickness, which first wall thickness is smaller than a wall thickness in a region surrounding the acoustic region, wherein the acoustic region is designed to be excited at least in sections into Lamb oscillations;
at least one ultrasonic transducer, wherein the ultrasonic transducer is located in a coupling region, wherein the ultrasonic transducer is designed to excite Lamb oscillations or to detect Lamb oscillations in the respective coupling region;
an electronic measuring/operating circuit for operating the ultrasonic transducer and for producing and providing measured values of the property of the medium,
wherein a supporting device is designed to support, at least in sections, the acoustic region against media pressure, wherein at least one supporting member is designed to absorb forces generated by media pressure,
wherein the supporting member has at least one decoupling device which is designed to reduce ultrasonic input of at least one associated acoustic region into the supporting member, and vice versa.

A supporting member without a decoupling device would interfere with the propagation of the Lamb oscillations in the acoustic region of the measuring tube wall, since these oscillations enter the supporting member in a non-negligible manner. Conversely, ultrasonic oscillations could also enter the acoustic region via the supporting member. The decoupling device therefore ensures good functioning of the ultrasonic measuring device even under high media pressure.

The ultrasonic measuring device is designed to measure at least one of the following parameters:
an ultrasonic signal transit time, an ultrasonic signal transit time difference between the ultrasonic transducers of an ultrasonic transducer pair, an ultrasonic signal Doppler shift, or ultrasonic signal amplitude,
and to derive measured values for the at least one media property therefrom.

For example, variables such as flow rate or sound velocity of the medium can be determined from the signal transit time or signal transit time difference. For example, an acoustic impedance of the medium can be derived from the amplitude. A flow rate can also be determined from the ultrasonic signal Doppler shift, for example.

In one embodiment, the supporting member surrounds the measuring tube in at least one cross-section an acoustic region and covers the acoustic region at least in sections.

In one embodiment, the decoupling device comprises a damping device which is designed to dampen ultrasound penetrating into the supporting member or ultrasound passing from the supporting member into the acoustic region.

In one embodiment, the damping device has cavities which are filled with a gas such as air, for example.

In one embodiment, a surface of the decoupling device has an uneven contour and provides supporting points or supporting lines or supporting surfaces.

In one embodiment, the ultrasonic measuring device is suited for measuring media properties at media pressures up to at least 25 bar, and in particular at least 51 bar and preferably at least 68 bar.

In one embodiment, the ultrasonic transducers are interdigital transducers.

In one embodiment, the interdigital transducers are covered by a supporting member.

In one embodiment, a damping element is arranged between the supporting member and the interdigital transducer, wherein the supporting member is designed to press the damping element against the interdigital transducer.

In one embodiment, the supporting member has a supporting element, wherein the decoupling device is designed as a decoupling element, wherein the supporting element has a seat for the decoupling element in which the decoupling element is located.

In one embodiment, the supporting device is supported by the measuring tube.

In one embodiment, the supporting element or the supporting member consists of a plurality of parts, wherein individual parts are detachably fastened to one another.

In one embodiment, the measuring device has at least one pair of ultrasonic transducers, each of which is located in a coupling region.

In this way, for example, a transit time difference measurement or a flow measurement based thereon can be carried out.

In a method according to the invention for producing a supporting member of an ultrasonic measuring device according to one of the preceding claims, the supporting member is produced by casting, wherein casting tools are applied to the measuring tube.

In one embodiment, a decoupling element is fixed in an acoustic region before the supporting member is cast, and is enclosed in the cast by the casting.

The invention will now be described with reference to exemplary embodiments.

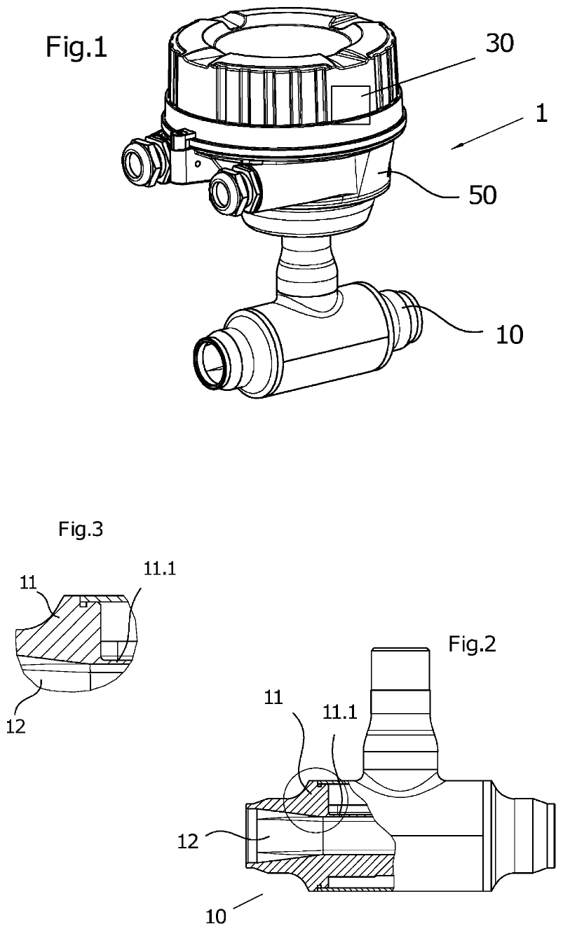

FIG. 1 is an oblique view of an exemplary ultrasonic measuring device according to the invention;

FIG. 2 is a side view of a measuring tube of the ultrasonic measuring device according to the invention with a partial section;

FIG. 3 is a detail view of the section;

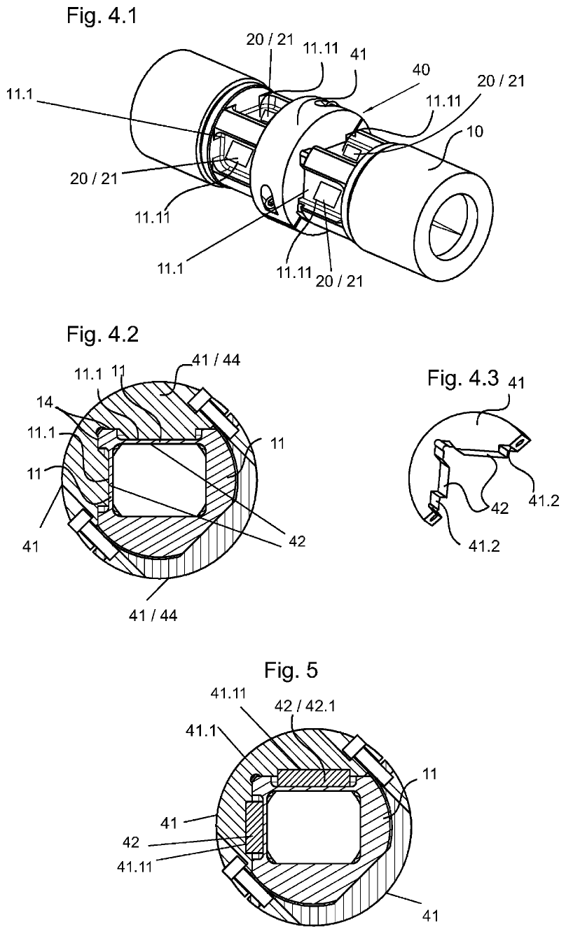

FIG. 4.1 is an oblique view of an exemplary embodiment of a measuring tube of an ultrasonic measuring device according to the invention;

FIG. 4.2 illustrates a cross-section through an exemplary supporting member according to the invention;

FIG. 4.3 is an oblique view of a component of the supporting member shown in FIGS. 4.1 and 4.2;

FIG. 5 shows an alternative embodiment of a supporting member according to the invention;

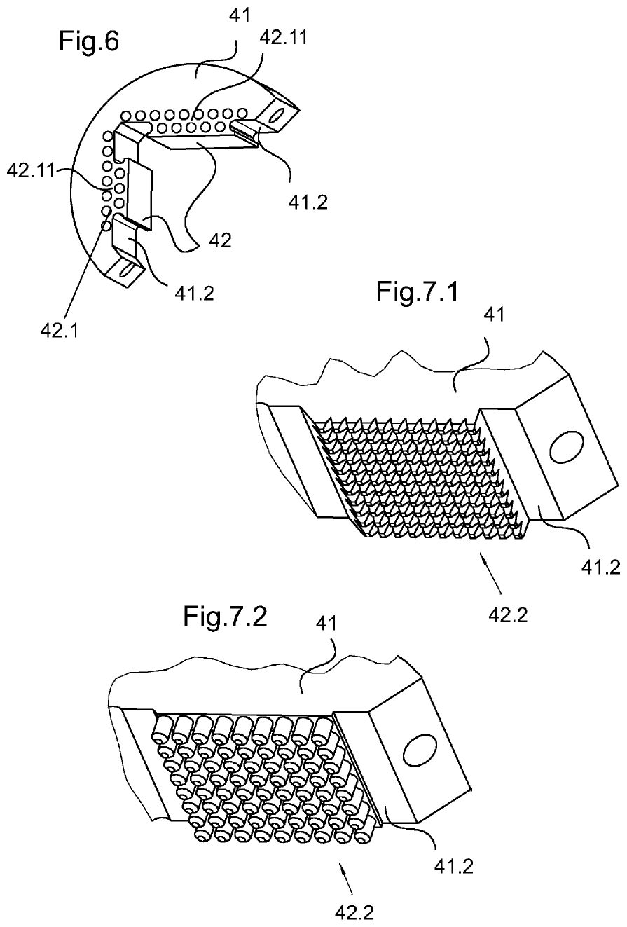

FIG. 6 is an oblique view of an alternative embodiment of the component of the supporting member shown in FIG. 4.3;

FIGS. 7.1 and 7.2 illustrate two exemplary embodiments of the supporting member according to the invention;

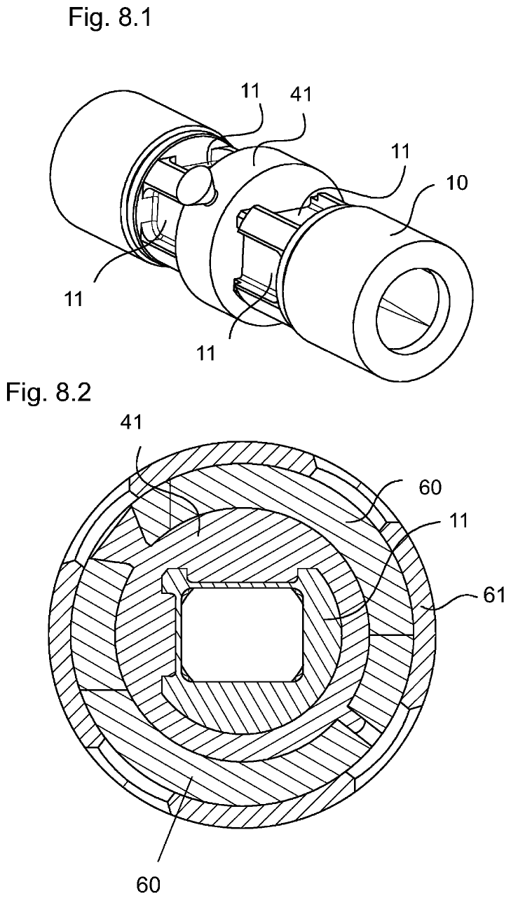

FIGS. 8.1 and 8.2 illustrate a production method according to the invention in which the supporting member is cast around the measuring tube.

FIG. 1 is an oblique view of an ultrasonic measuring device having a measuring tube 10, a housing 50, and an electronic measuring/operating circuit 30 located in the housing. The electronic measuring/operating circuit is designed to operate ultrasonic transducers (see FIG. 4.1) of the ultrasonic measuring device and to generate and provide measured values of the property of the medium.

FIG. 2 is a side view of the measuring tube 10, shown in FIG. 1, with a partial section, wherein the measuring tube has a measuring tube wall 11, with an acoustic region 11.1, and a measuring tube lumen containing the medium. In the acoustic region, the measuring tube wall is flat and has a constant, first wall thickness, which first wall thickness is smaller than a wall thickness in a region surrounding the acoustic region, wherein the acoustic region is designed to be excited at least in sections into Lamb oscillations. A measuring tube may also have more than one acoustic region, wherein at least one ultrasonic transducer is assigned to each acoustic region.

The wall thickness of the acoustic region depends upon the material properties of the measuring tube and upon the frequency or a frequency range of the ultrasonic signals generated by the ultrasonic transducers. In steel, for example, the wall thickness is in the range of 1 millimeter at a central frequency of the ultrasonic signals of 1.5 MHz. At 0.5 MHz, it is approximately 3 millimeters. A person skilled in the art is able to transfer this to his own implementation.

FIG. 3 is an enlarged cutout of the section of the measuring tube shown in FIG. 2.

FIG. 4.1 is an oblique view of an exemplary embodiment of a measuring tube of an ultrasonic measuring device according to the invention, wherein the measuring tube has two acoustic regions 11.1, each having a pair of ultrasonic transducers 20, which, as illustrated schematically here, can be designed as interdigital transducers 21. The ultrasonic transducers can, for example, also each have a coupling element and a transducer element, as illustrated schematically in DE102018133066A1.

The ultrasonic transducers are each arranged in a coupling region 11.11 of an associated acoustic region 11.1 and are designed to generate Lamb oscillations or to detect Lamb oscillations in the respective coupling regions. Ultrasonic signals are coupled into the medium or decoupled from the medium by means of the Lamb oscillations. By influencing the ultrasonic signals through the medium, media properties can be determined by evaluating detected Lamb oscillations. For example, a flow rate and/or sound velocity of the medium can be determined from a transit time difference. Further media properties can be derived from the sound velocity.

A supporting device 40 comprising a supporting member 41 is designed to support the acoustic regions against high media pressure, so that reliable operation of the ultrasonic measuring device is ensured even with such media pressures.

Alternatively, a flow meter according to the invention can have only one ultrasonic transducer, wherein a measurement of an ultrasonic signal Doppler shift or a signal transit time is used to measure a media property.

FIG. 4.2 illustrates a schematic cross-section through the supporting member shown in FIG. 4.1, wherein the supporting member rests on the measuring tube wall 11 in the region of the acoustic regions 11.1. Stop surfaces 14 of the measuring tube provide the supporting member a grip for precise positioning. As shown here, the supporting member can be designed in two parts, so that the supporting member can be easily mounted on the measuring tube—for example, by means of a screw connection, as indicated. The supporting member can be produced from carbon steel or stainless steel. For example, individual parts can be machined cast components.

Alternatively, as shown in FIGS. 8.1 and 8.1, the supporting member can also be mounted on/attached to the measuring tube by casting. In each of the supporting regions, the supporting member has a decoupling device 42 which is designed to reduce acoustic coupling between the acoustic region of the measuring tube and the supporting member. Specific exemplary embodiments of these decoupling devices are shown in FIG. 5, FIG. 6, and FIGS. 7.1 and 7.2.

FIG. 4.3 is an oblique view of a part of the supporting member shown in FIG. 4.2, which provides a stop surface 41.2 for a stop surface 14 of the measuring tube.

FIG. 5 illustrates an exemplary embodiment of the decoupling device 42 according to the invention by means of a cross-section through the supporting member 41, wherein the supporting member has a supporting element 41.1 with two seats 41.11 and a decoupling device 42 in the form of a damping device 42.1. The damping device can, for example, as shown here, be an acoustically damping insert arranged in a respective seat. This insert can, for example, be fixed and pressed against the measuring tube by means of the supporting element. For example, the insert may comprise at least one of the following materials: PTFE, graphite, epoxy resin, epoxy resin mixed with, for example, metal/metal oxide powder, CFC (carbon-fiber-reinforced plastic), polyurethane, or cork. However, the insert may also have a paste or a gel. For example, an embodiment, corresponding to that in FIG. 5, of the supporting member can also be used in interdigital transducers, wherein the supporting member is designed to press the damping device against the interdigital transducer.

FIG. 6 is an oblique view of a part, shown in FIG. 4.2, of the supporting member with an exemplary embodiment of the decoupling device 42, which is equipped with a damping device 42.1 with a plurality of cavities 42.11 such as, for example, bores or holes, which cavities are arranged in spatial proximity to a contact region with the acoustic region. The cavities scatter and break ultrasonic waves, so that only a small amount of coherent ultrasonic energy can be exchanged between the measuring tube and the supporting member.

Alternatively or additionally, a surface of the decoupling device can be structured in the contact region with the measuring tube as shown in FIGS. 7.1 and 7.2, and thus reduce an exchange of ultrasonic waves between the supporting member and the acoustic region of the measuring tube. As shown, the surface may have a plurality of pyramidal or cylindrical projections, which are arranged in a regular pattern, for example. By reducing the contacts on points or lines or small surfaces, the exchange of ultrasonic waves can be well reduced. The surface can be produced, for example, by milling or selective material application or similar production methods.

The supporting member or part of the supporting member shown here is produced, for example, at least partially by milling, drilling, or selective material application such as 3-D printing or laser melting. The supporting members shown here are not to be interpreted as limiting. A person skilled in the art can adapt the inventive idea of the acoustic decoupling between the supporting member and the measuring tube to his needs. This also applies with regard to the number and arrangement of the supporting members on the measuring tube.

FIGS. 8.1 and 8.2 illustrate an exemplary embodiment of a one-piece supporting member 41, which is attached to the measuring tube by means of casting. As shown in cross-section in FIG. 8.2, various casting molds 60 are created during production, which leave free a cavity that defines the supporting member, which cavity is filled with a cast material. The cast material preferably has an acoustically dampening effect, such as aluminum foam or an epoxy resin or the like. The casting molds can be held by a retaining ring 61, for example. After casting, protruding sprue funnels or casting overflows (as shown) are removed after the casting has hardened.

A person skilled in the art is free to choose the number and arrangement of the supporting members on the measuring tube. The exemplary embodiments shown here are not to be interpreted as limiting.

By setting up a supporting device according to the invention, the ultrasonic measuring device is suited for measuring media properties at media pressures up to at least 25 bar, and in particular at least 51 bar and preferably at least 68 bar.

### LIST OF REFERENCE SIGNS

1 Ultrasonic measuring device
10 Measuring tube
11 Measuring tube wall
11.1 Acoustic region
11.11 Coupling region
12 Measuring tube lumen
14 Stop surface
20 Ultrasonic transducer
21 Interdigital transducer
30 Electronic measuring/operating circuit
40 Supporting device
41 Supporting member
41.1 Supporting element
41.11 Seat
41.2 Stop surface
42 Decoupling device
42.1 Damping device
42.11 Cavity
42.2 Surface of the decoupling device
43 Decoupling element
44 Part
50 Housing
60 Casting mold
61 Retaining ring

1-15. (canceled)

16. An ultrasonic measuring device for measuring at least one property of a medium located in a measuring tube, said device comprising:
the measuring tube including a measuring tube wall and a measuring tube lumen;
wherein the measuring tube wall has at least one acoustic region, in each case having at least one coupling region, wherein the measuring tube wall is flat in the acoustic region and has a constant, first wall thickness, which first wall thickness is smaller than a wall thickness in a region surrounding the acoustic region;
at least one ultrasonic transducer, wherein the ultrasonic transducer is located in a coupling region, wherein the ultrasonic transducer is designed to excite Lamb oscillations or to detect Lamb oscillations in the respective coupling region;
an electronic measuring/operating circuit for operating the ultrasonic transducer and for producing and providing measured values of the property of the medium,
wherein a supporting device is designed to support the acoustic region at least in sections against media pressure, wherein at least one supporting member is designed to absorb forces generated by media pressure,
wherein the supporting member has at least one decoupling device which is designed to reduce ultrasonic input from at least one associated acoustic region into the supporting member, and vice versa.

17. The ultrasonic measuring device according to claim 16,
wherein the supporting member surrounds the measuring tube in at least one cross-section of an acoustic region and covers the acoustic region at least in sections.

18. The ultrasonic measuring device according to claim 16,
wherein the decoupling device comprises a damping layer which is designed to dampen ultrasound penetrating into the supporting member or ultrasound passing from the supporting member into the acoustic region.

19. The ultrasonic measuring device according to claim 18,
wherein the damping layer has cavities which are filled with a gas.

20. The ultrasonic measuring device according to claim 16,
wherein a surface of the decoupling device has an uneven contour and provides supporting points or supporting lines.

21. The ultrasonic measuring device according claim 16,
wherein the ultrasonic measuring device is suited for measuring media properties at media pressures up to at least 25 bar.

22. The ultrasonic measuring device according to claim 16,
wherein the ultrasonic transducers are interdigital transducers.

23. The ultrasonic measuring device according to claim 22,
wherein the ultrasonic transducers are covered by a supporting member.

24. The ultrasonic measuring device according to claim 23,
wherein a damping device is located between the supporting member and the interdigital transducer, wherein the supporting member is designed to press the damping device against the interdigital transducer.

25. The ultrasonic measuring device according to claim 16,
wherein the supporting member has a supporting element, wherein the decoupling device is designed as a decoupling element,
wherein the supporting element has a seat for the decoupling element in which the decoupling element is located.

26. The ultrasonic measuring device according to claim 16,
wherein the supporting device is supported by the measuring tube.

27. The ultrasonic measuring device according to claim 16,
wherein the supporting element or the supporting member consists of a plurality of parts, wherein individual parts are detachably fastened to one another.

28. The ultrasonic measuring device according to claim 16,
wherein the measuring device has at least one pair of ultrasonic transducers, each of which is located in a coupling region.

29. A method for producing a supporting member of an ultrasonic measuring device according to claim 16,
wherein the supporting member is produced by casting.

30. The method according to claim 29,
wherein, before the supporting member is cast, a decoupling element is fixed in an acoustic region and is enclosed in the cast by the casting.
